(19) United States
(12) Patent Application Publication
(10) Pub. No.: US 2021/0045421 A1
(43) Pub. Date: Feb. 18, 2021

(54) NUTRAMEAL - A NUTRITIONAL COMPOSITION TO MEET DAILY CALORIE AND NUTRITION NEEDS OF A HUMAN BEING

(71) Applicant: Mughda Vipul Dave, Kharghar, Maharashtra (IN)

(72) Inventor: Isha Vipul Dave, Kharghar, Maharashtra (IN)

(21) Appl. No.: 16/483,372

(22) PCT Filed: May 29, 2018
(86) PCT No.: PCT/IB2018/053804

§ 371 Date: Aug. 2, 2019

(30) Foreign Application Priority Data
Jun. 5, 2017 (IN) 201721004122

(51) Int. Cl. A23L 27/00; A23L 27/40; A23L 7/10; A23L 27/12; A23L 27/14

(52) U.S. Cl. CPC A23L 27/88; A23L 27/40; A23L 33/40; A23L 27/12; A23L 27/14; A23L 7/198

(57) ABSTRACT

The present invention discloses a nutritional dietary formulation with an appropriate weight of weeds comprising whole weed Amaranthus retroflexus (pigweed), whole weed Taraxacum officinale (dandelion) excluding unwanted parts of the roots, whole weed Urtica dioica (stinging nettles) excluding its nettles, and whole weed Chenopodium album (lamb's quarters), in the ratio of 5:4:2:4 and corn meal in amount of 250 grams. It is prepared from ubiquitously available and otherwise discarded weeds and cornmeal. Thus, it is economical. Further, it is a wholesome meal that supplies calories both quantitatively and qualitatively. The micronutrients are also balanced. The present invention provides dietary nutritional formulations that meet the Recommended Dietary Allowance (RDA) of all types of human groups including the healthy human beings and under nourished human population.

### TECHNICAL FIELD

Present invention relates to food technology and more particularly to a dietary nutritional formulation prepared from weeds. The dietary nutritional formulation disclosed in the present invention meets the Recommended Dietary Allowance (RDA) of an adult human in the most economic way as it is prepared from ubiquitously available and otherwise discarded weeds and the cornmeal.

### BACKGROUND OF THE INVENTION

Many countries including India face the dual problems of under-nutrition and low agricultural productivity due to weeds. Budgetary allocations to tackle these problems may be obtained from the Economic Survey of that financial year.

The conventional method of tackling the problem of weeds is by investing in weed control methods, weed control research and management and also providing compensation for losses or low productivity. Thus, governmental organisations, research institutes, farmers spend considerable money and efforts in weed control activities. The effort is due to traditional belief that weeds are unwanted plants that grow rampantly even at extreme environmental conditions; compete with crops for sunlight, water, nutrients and space; and has no significance in human life for any purpose. In the last decade, non-toxicity and medicinal value of weeds have been a subject of interest. But, never have weeds been used or advocated as food substitutes or as a wholesome formulation.

The conventional method of tacking the problem of under-nutrition is by prioritising the vulnerable sections. In India, every financial year the scope of existing nutritional schemes is widening and new schemes are introduced under the National Health Mission (NHM). One drawback of this approach is the average middle-class adult is not accounted.

It shall be noted that in spite of enormous efforts, according to Indian Council for Agricultural Research (ICAR) statement India loses agricultural produce worth over $11 billion annually to weeds. This is quantitatively more than the Centre's budgetary allocation for agriculture for 2017-18. Further, according to 2017 Global Hunger Index (GHI), India is ranked 100 of 119 countries.

It is clearly evident that conventional methods have fallen short, there is a need for indigenous research that deviates from the traditional approaches and integrates the two problems and thereby converting our liabilities into an asset. One such approach is dietary nutritional formulation using weeds.

The said approach is extremely challenging due to the mammoth task of standardisation that is required. The non-toxic edible weeds need to be selected and the right proportions in which they need to be added has to be established. The right proportion must ensure that calories are obtained in a balanced manner. Further, optimisation of nutritional dietary formulation for satiety is required.

Further, let it also be noted that an average individual eats about 1-1.5 kg of food in a day, putting together all the meals he/she has. Also, children require about 1600 Cal/day, rural women require about 2000 Cal/day and rural men require about 2200 Cal/day, which is more than the urban folk. However, wrong eating habits/lack of awareness about the importance of a healthy diet many a time end up in malnutrition. Even large quantity meals don't fulfil the required calorie and nutritional needs. The planned diet or the nutritional formulae available today are unaffordable to the general public due to their high prices. An average vegetarian individual needs a good-sized intake of pulses, legumes, grains, vegetables, fruits, dry fruits, oils, and dairy to meet his qualitative nutritional requirement per day. The cost of all this would practically run very high. In fact, in under-developed and developing nations, achieving the required amount of nutrition would heavily exceed the budget of the family due to the lower per capita income of an average below poverty line individual.

This invention provides a wholesome dietary nutritional formulation from weeds that successfully links problems of agriculture with problems of nutritional needs and also has a life-cycle approach from birth to death. Further, optimisation of nutritional dietary formulation for satiety is also ensured. Macronutrients are in the right proportion so the total calorie requirement is met quantitatively and qualitatively. The said dietary nutritional formulation provides the nutritional benefits of every type of food, including that of dairy products at very cheap price. In fact this dietary nutritional formulation is beneficial for human beings who are lactose intolerant.

### OBJECT OF THE INVENTION

The main object of this invention relates to a dietary nutritional formulation devised to meet the daily qualitative and quantitative nutrient and calorie needs of an individual.

Another object of this invention is to fight malnutrition in an extremely cheap manner using weeds.

### SUMMARY OF THE INVENTION

The present invention provides a dietary nutritional formulation that meets the Recommended Dietary Allowance (RDA) of an adult human in the most economical way as it is prepared from ubiquitously available and otherwise discarded weeds and cornmeal.

The said dietary nutritional formulation contains appropriate amounts of whole weed Amaranthus retroflexus (pigweed), whole weed Taraxacum officinale (dandelion) excluding unwanted parts of the roots, whole weed Urtica dioica (stinging nettles) excluding its nettles, and whole weed Chenopodium album (lamb's quarters) and a food binder. Food binders add volume, flavor, texture, and firmness to the formulation. The present invention uses cornmeal as the food binder. Further, additional ingredients may be added to increase palatability.

A holistic approach is needed to promote the concept of healthy nutrition. The present invention has a multi-sectoral innovative approach to involve all age groups, keeping in view cultural diversity in food habits and earning capacity. Availability of nutritious foods at low cost was ensured.

Food energy calorie requirement is a function of age, sex, and physical activity. Looking at the complexity of food technology, the precision in selecting the non-toxic weeds and combining them in ratios that will provide the Recommended Dietary Allowance (RDA) is a critical challenge.

Further, the nature of the food constituent from which the calorie is obtained is also important. Thus, for optimum health; calorie intake must be obtained from right amounts of carbohydrates, proteins, and fats. Hence, it is a challenge to establish the ratio of selected weeds and the total amount of the nutritional dietary formulation administered such that the formulation provides calories quantitatively and qualitatively by ensuring a balance of macronutrients.

Thus, the present invention provides proteins, carbohydrates, and fats in the right proportion. Further, the micronutrients are also balanced to the most optimum level.

Also, the main role of food is to satisfy hunger and to provide essential energy, nutrients and other substances for growth and the maintenance of health. Some foods can more easily contribute to the feeling of fullness (satiety) than others, and this is referred to as their “satiating power”. The satiating power of weeds is less. The selection of an appropriate binder and establishing the amount in which it should be added to provide a dietary nutritional formulation that is satiating is also a challenge. All these challenges are successfully handled in present invention by providing correct formulations of weeds and corn meal.

### DESCRIPTION OF DRAWINGS

FIG. 1 is a pictorial depiction of weed Amaranthus retroflexus (pigweed)

FIG. 2 is a pictorial depiction of weed Taraxacum officinale (dandelion)

FIG. 3 is a pictorial depiction of weed Urtica dioica (stinging nettles)

FIG. 4 is a pictorial depiction of weed Chenopodium album (lamb's quarters)

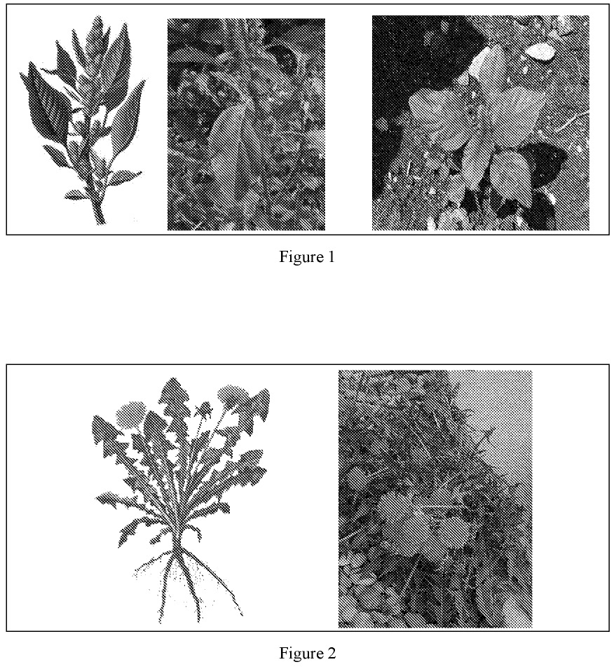

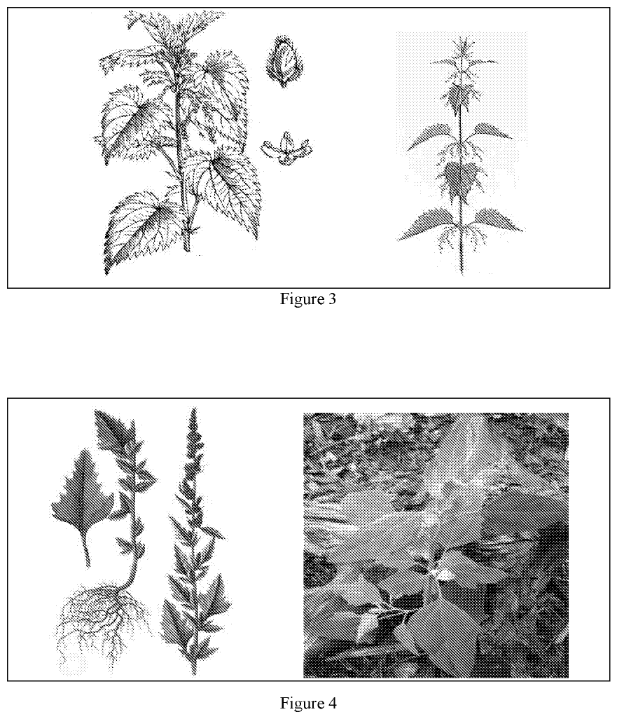

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity; but include the general class of which a specific example may be used for illustration. The terminology herein is used to describe specific embodiments of the invention, but their usage, does not delimit the invention, except as outlined in the claims.

The present invention provides a dietary nutritional formulation of an all-nutritive meal which qualitatively, as well as quantitatively includes all nutrients and is composed majorly of non-toxic edible weeds that are judiciously selected. The dietary nutritional formulation comprises weeds of Amaranthus retroflexus (pigweed), Taraxacum officinale (dandelion), Urtica dioica (stinging nettles), and Chenopodium album (lamb's quarters) in the ratio of 5:4:2:4.

Also, both, fresh weeds and dried weeds may be used. Dried weeds are weeds that are dried or dehydrated by conventional methods. Drying is advantageous because weeds can be stored for later use without loss of required quantity nutrients and thereby the nutritional formulation will be available throughout the year.

Further, cornmeal was selected for its roles as a binder, an ingredient to increase the satiety power of food and to increase palatability. It is further advantageous because the nutritional dietary formulation can be administered to a section of the society that is vulnerable to gluten sensitivity or have celiac disease. Further, the said dietary nutritional formulation is beneficial for human beings who are lactose intolerant. A large proportion of world population suffers from celiac disease and lactose intolerance.

The conventional approach of formulating nutritional dietary composition is to establish the ratio of each ingredient and then vary the dosage depending on the requirement for the specific age group. The present invention uses a differing approach and cornmeal quantity is kept constant at 250 grams in all formulation.

Without, this approach it is not possible to balance the different roles of cornmeal. Hence there is no direct proportionality. Also, cornmeal may be roasted using 15 grams of coconut oil. Further other food ingredients may be added to enhance taste and for nutritional value. More particularly dehydrated fruits of apple, banana, grapes, guava, jackfruit, mango may be used.

In one aspect of the invention, fresh weeds in the ratio of 5:4:2:4 are used to prepare the nutritional composition that meets the dietary needs of an adult human. More specifically when fresh weeds are available it comprises at least 250 g of whole weed Amaranthus retroflexus (pigweed), 200 g of whole weed Taraxacum officinale (dandelion) excluding unwanted parts of the roots, 100 g of whole weed Urtica dioica (stinging nettles) excluding its nettles, and 200 g of whole weed Chenopodium album (lamb's quarters). Further, cornmeal quantity is 250 grams. The unwanted parts of the roots of Taraxacum officinale (dandelion) comprise root hairs and tertiary roots. It is removed because it affects the powder nature of the formulation as the threads of tertiary roots cannot be ground into fine powder. Also, the quantity of contaminants is higher in these unwanted parts of the root and cleaning may not be sufficient. Hence, it is discarded.

The fresh weeds are cleaned and unwanted parts of the plant are removed. The unwanted parts of the weeds are more particularly tertiary roots of Taraxacum officinale (dandelion) and nettles of Urtica dioica (stinging nettles). The weeds are washed thoroughly to remove contaminants and traces of pesticides. The conventional methods of washing, preferably acid wash may also be used. It is further chopped into suitable pieces and 250 grams of cornmeal is added. Further additional ingredients like dry fruits, spices, dried fresh fruits may be added. The selection of Cornmeal is advantageous as it enhances the taste and gives a higher acceptability. If roasted cornmeal is used, coconut oil of 15 grams is added.

Any ingredient or the entire mixture can optionally be heated to homogenize, cook the ingredients sufficiently.

This nutritional composition provides following nutrients:

Calorie content: 2271 Cal

Protein content: 75 g

Carbohydrate content: 414 g

Fat content: 35 g

Fiber content: 58 g

Potassium content: 3185 mg

Phosphorous content: 847 mg

Sodium content: 341.5 mg

Iron content: 33.75 mg

Calcium content: 2750 mg

Vitamin A content: 3825 mg to 9562.5 mg

Vitamin C content: 113.4 mg to 283.5 mg

This is a wholesome nutritional dietary formulation that is administered to a healthy human. More specifically this formulation having at least 750 grams of fresh weeds with 250 grams of corn meal meets the recommended dietary allowance of a healthy human being of age above 12 years.

Additionally dehydrated fruits can be added to it.

In the second aspect of the present invention, the dried weeds are used instead of fresh weeds. In all nutritional dietary formulations using dried weeds, the dried weeds comprising whole weed Amaranthus retroflexus (pigweed), whole weed Taraxacum officinale (dandelion) excluding unwanted parts of the roots, whole weed Urtica dioica (stinging nettles) excluding its nettles, and whole weed Chenopodium album (lamb's quarters) are taken in the said established ratio of 5:4:2:4 whereas cornmeal is 250 grams. The weeds were dried under mild conditions to preserve the integrity of the cellular structures while completely removing water content from them.

Moisture content influences the taste, texture, weight, appearance, and shelf life of any dietary formulation. In general, even a slight deviation from a defined standard can adversely impact the physical properties of nutritional dietary formulations. For example, substances which are too dry could affect the consistency of the end product and leave an unacceptable aftertaste. Conversely, excess moisture may cause the nutritional dietary formulation to agglomerate. Also, the rate of microbial growth increases with total water content, possibly resulting in spoiled batches that need to be disposed of. However, water is essential to give a formulation that is easy to consume. For these reasons, the present invention engages in the delicate balancing of moisture and total solids to ensure consistent product quality, safety, and profitability.

Dried weeds herein are defined as weeds wherein the moisture content cannot be more than 14% after drying under mild conditions.

The present invention discloses the following three dried weed formulation:

i. Weed Formulation Using 60 to 80 Grams of Dried Weeds

In this formulation, instead of fresh weeds; dried weeds may be used. In fact, one-tenth amount of each dried weed is sufficient as drying majorly results in weight reduction due to loss of water. Thus, the weight of total dried weed can be adjusted between 60 to 80 grams for this formulation. Completely dried weeds to dried weeds containing up to 14 percent of the moisture content originally present may be used.

When formulated with 60 to 80 grams and more particularly with 75 grams of total dried weed in the above proportion i.e. 1/10th of 750 grams of fresh weed used in the first aspect of the present invention; the nutritional dietary formulation is sufficient for preparing a wholesome meal for children from the age of 1 to 6. Children in the age group 1-6 require 1060-1350 calories.

Explaining further, the total weight of the above said formulation administered to this age group is between 310 to 330 grams when mixed with 250 grams of cornmeal.

In first embodiment when completely dried weeds without any moisture, then 60 grams dried weed formulation provides minimum around 1177 calories that are qualitatively achieved from a right balance of proteins (25-29.5 grams), carbohydrates (240-243.1 grams) and fats (6.8-6.9 grams). Then, the 75 gm dried weed formulation provides around 1245 calories that are qualitatively achieved from a right balance of proteins (28.5-32.5) grams, carbohydrates (250-254.5 grams) and fats (7.3-7.5 grams) And 80 gm dried weed formulation provides around 1261 calories that are qualitatively achieved from a right balance of proteins (30-33.5 grams), carbohydrates (253-258.3 grams) and fats (7.5-7.9 grams). The micronutrients are also balanced. Further when the corn meal to be used in the said formulations is roasted in 15 grams of oil; the fat content up to 21.9 grams, 22.3 grams and 22.7 grams is obtained from nutritional dietary formulations containing 60 grams, 75 grams and 80 grams weeds respectively.

In first embodiment when dried weeds with 14% moisture are used; the 60 grams dried weed formulation provides around 1135 calories that are qualitatively achieved from a right balance of proteins (25-27.5 grams), carbohydrates (235-240.1 grams) and fats (6.3-6.7 grams). More particularly, the 75 gm dried weed formulation provides around 1190 calories that are qualitatively achieved from a right balance of proteins (27.5-30.5) grams, carbohydrates (240-245.5 grams) and fats (6.9-7 grams) The 80 gm dried weed formulation provides around 1205 calories that are qualitatively achieved from a right balance of proteins (29-31 grams), carbohydrates (245-248.3 grams) and fats (7.1-7.3 grams). The micronutrients are also balanced. Further when the corn meal to be used in the said formulations is roasted in 15 grams of oil; the fat content up to 21.9 grams, 22.3 grams and 22.7 grams is obtained from nutritional dietary formulations containing 60 grams, 75 grams and 80 grams weeds respectively.

These nutrients are complimentary to the dietary needs of the healthy human being of age between 1 to 6 years.

In other embodiment of the present invention, the present invention discloses a nutritional composition that meets the second objective of fighting malnutrition. A malnourished human being is defined as a person suffering from malnutrition; a condition that develops when the body does not get the right amount of the macronutrients and vitamins, minerals, and other nutrients it needs to maintain healthy tissues and organ function. Within, the ambit of its definition falls both undernourishment and over nourishment.

Overnutrition results from eating too much, eating too many of the wrong things, not exercising enough, or taking too many vitamins or other dietary replacements. Thus, over nourishment being a consequence of the human beings choice and/or action or inaction; an over nourished person can be put on a regular adult diet with minor withdrawal symptoms caused due to intense craving for carbohydrates and fats.

Undernutrition is a consequence of consuming too few essential nutrients and/or excreting them more rapidly than they can be replaced. This problem is far more complicated than overnutrition as the human being looses the ability to assimilate protein and also has severe loss of appetite. The risk of kidney failure and diarrhea is high. If such person is given a diet appropriate for his age, the nutrients will not be absorbed and the person will excrete it more rapidly than it can be replaced. It is therefore not possible to directly put the individual on a healthy diet in case of undernourishment. Initially, such person is given clinical feeding and then administered therapeutic food and he continues on this food for a determined period of time. Generally, Ready-to-use therapeutic food (RUTF), also referred to as energy dense nutritious food (EDNF), is a medical intervention to improve the nutrition intake of human beings especially children suffering from Severe Acute Malnutrition (SAM). RUTF is a packaged paste of which contains around 520 calories of energy per 100 g wherein 10-12 percent of the total calories come from proteins. A person is given 3 packets in a day. Thus, the protein content given to such person through RUTF is only up to 30-35 grams a day and not more. It is the recommended limit of the protein for such undernourished person.

Being complying with the recommended dietary allowance of a malnourished human being, the nutritional dietary formulation having 60 to 80 grams of dried weeds with 250 grams of corn meal is appropriate diet for such human beings and it is safe for consumption. Further when the corn meal to be used in the said formulations is roasted in 15 grams of oil; the fat content up to 21.9 grams, 22.3 grams and 22.7 grams is obtained from nutritional dietary formulations containing 60 grams, 75 grams and 80 grams weeds respectively. Majority of those affected by undernutrition are children. This formulation is highly beneficial for children suffering from Marasmus and Kwashiorkor. 8% of India's GDP is lost in fighting malnutrition annually.

The said nutritional dietary formulations that are disclosed in the present invention demonstrate a high satiety value and are made available at a low cost. Additionally dehydrated fruits can be added. Thus, the present formulations also fight malnutrition across the entire human spectrum.

ii. Weed Formulation Using 140 to 160 Grams of Dried Weeds

The total weight of the above said formulation is between 390 to 410 grams when mixed with 250 gms of cornmeal.

In one embodiment when the completely dried weeds are used, the 140 gm dried weed formulation provides calories of around 1513 calories that are qualitatively achieved from a right balance of proteins (40-45.5 grams), carbohydrates (295-303.9 grams) and fats (10-10.1 grams). The 150 gm dried weed formulation provides calories of around 1560 calories that are qualitatively achieved from a right balance of proteins (43-47.5 grams), carbohydrates (305-311.5 grams) and fats (10.5 grams). The 160 gm dried weed formulation provides calories of around 1600 calories that are qualitatively achieved from a right balance of proteins (44-50 grams), carbohydrates (315-319.1 grams) and fats (10.9 grams). It may further include appropriate quantity of coconut oil for roasting of cornmeal. This may further enhance the calorie content of the formulation wherein the fat content is 25.1 grams, 25.5 grams and 25.9 grams respectively.

In another embodiment when the dried weeds with 14% moisture are used; the 140 grams dried weed formulation provides around 1420 calories that are qualitatively achieved from a right balance of proteins (41-43 grams), carbohydrates (285-287 grams) and fats (9-9.2 grams). More particularly, the 150 grams dried weed formulation provides around 1450 calories that are qualitatively achieved from a right balance of proteins (42-45) grams, carbohydrates (290-294 grams) and fats (9.5-9.7 grams) The 160 grams dried weed formulation provides around 1500 calories that are qualitatively achieved from a right balance of proteins (42-45.5 grams), carbohydrates (295-300 grams) and fats (9.8-9.9 grams). The micronutrients are also balanced. Further when the corn meal roasted in 15 grams of oil and is used in the said formulation; the fat content up to 24.2 grams, 24.5 grams and 24.9 grams is obtained from nutritional dietary formulations containing 140 grams, 150 grams and 160 grams weeds respectively.

Also, after the adult under nourished population has begun assimilating the formulation of i. i.e. 60 to 80 grams of dried weeds formulation, intermediate dosage is required to avoid protein indigestion. Thus, this formulation helps in gradual fight against malnutrition.

Further, this formulation having 140 to 160 grams of dried weeds with 250 grams of corn meal meets the recommended dietary allowance of a healthy human being of age between 7 to 9 years. The micronutrients are also balanced. Additionally dehydrated fruits can be added to it.

iii. Dry Weed Formulation Similar to the First Aspect of the Present Invention Wherein Fresh Weed is Replaced by a Suitable Established Quantity of Dried Weed

In the first aspect of the present invention, weeds are selected from fresh weeds comprising at least 250 g of whole weed Amaranthus retroflexus (pigweed), 200 g of whole weed Taraxacum officinale (dandelion) excluding unwanted parts of the roots, 100 g of whole weed Urtica dioica (stinging nettles) excluding its nettles, and 200 g of whole weed Chenopodium album (lamb's quarters). During food processing, fresh weeds are replaced by dried weeds to overcome the limitations of supply due to climatic factors. Thus, the equivalent amount of dried weeds of at least 274 grams is used to provide a nutritional dietary formulation providing at least 2075 calories from the right balance of proteins, carbohydrates and fats. When dried weeds up to 14% moisture are taken, the macronutrients namely protein (65-75 grams), fats (13-16 grams) and carbohydrates (375-405 grams) may be obtained. The micronutrients are also balanced; namely potassium, phosphorous, sodium, iron, calcium, vitamin A and vitamin C is also sufficient. Further, when roasted cornmeal is used, the fat content increases to 30-31 grams.

This is a wholesome nutritional dietary formulation that is administered to a healthy human. More particularly, this formulation having at least 274 grams of dried weeds with 250 grams of corn meal meets the recommended dietary allowance of a healthy human being of age above 12 years. Additionally dehydrated fruits can be added to it.

Also, use of high quantity of weeds around 400 grams are safe for consumption. It provides around 2400-2600 calories from the right balance of proteins (70-82 grams), carbohydrates and fats (15-20 grams). However, it may be noted that amounts above 400 grams of weeds may not suit all adult healthy human beings due to the high content of protein. Thus, it may be formulated in case of only special needs only.

Further, this nutritional composition has been designed to promote the versatility of consumption. With varying quantities of water, it can be turned into a better for making ‘chinas’, dosas' or ‘pakoras’; can be added to the staple grain and consumed in a baked form or can be consumed as an ‘upma’ substitute. With other additives like buttermilk, it can be taken as porridge too.

Thus, without deviating from the concept of the current invention, this nutritional composition can be prepared in various recipes.

Hereinafter, the invention is explained in detail in the following examples. These examples are provided with the intent of illustration only and therefore should not be construed to limit the scope of the invention in any way.

### Example 1

Fresh Amaranth retroflexus, Taraxacum officinale, Urtica dioica and Chenopodium album weeds were taken to prepare the nutritional dietary formulation. The unwanted parts of the roots of Taraxacum officinale and nettles of Urtica dioica were removed and all the weeds were washed with water thoroughly to remove the dust, soil etc. Thereafter the water was drained completely and following quantities of weeds were weighed, chopped and mixed together:

250 g of Amaranth retroflexus, 200 g of Taraxacum officinale, 100 g of Urtica dioica and 200 g of Chenopodium album

The binding base i.e. 250 g of Cornmeal was roasted in an iron pan using 15 g of the coconut oil. A medium flame of the stove was maintained for three minutes sharp, after which the corn meal was allowed to cool for another fifteen minutes under normal conditions. The mixture of already weighed weeds was added to this base and stirred well to mix the components and obtain the nutritional composition. Additionally, to enhance taste and increase further nutrients, 100 g of peeled and smashed banana along with salt and chilly as per the taste were added.

### Example 2

Fresh Amaranth retroflexus, Taraxacum officinale, Urtica dioica and Chenopodium album weeds were taken to prepare the nutritional composition. The unwanted parts of the roots of Taraxacum officinale and nettles of Urtica dioica were removed and all the weeds were washed with water thoroughly to remove the dust, soil etc. Thereafter the water was drained completely and the weeds were spread evenly on a large metal plate as such, without cutting/chopping and this set up was then covered with loin.

A banana was peeled and sectioned into thin transverse slices. Then the slices were laid out on a large plate such that no two slices overlap and were put under direct sunlight on the first day. On the next day, each slice was turned over in a manner that the other circular face can obtain direct sunlight. After carrying out this procedure, the slices were shade dried without any covering for another 5 days.

All the dried weeds and dried banana slices were powdered manually and kept in separate vessels. Following quantities of weeds and banana were taken in another pot to be mixed with corn meal binding base:

25 g of Amaranth retroflexus, 20 g of Taraxacum officinale, 10 g of Urtica dioica, 20 g of Chenopodium album and 25 g of banana

Thereafter the nutritional composition was prepared by following a procedure similar to Example 1; using 250 g of Cornmeal, 15 g of coconut oil, salt and chilly.

Further, various formulations were prepared from dried weeds in manner similar to the example 2 by taking dried weeds in the weight ratios disclosed in the description.

1. A dietary nutritional formulation to meet the recommended dietary allowance of a healthy human being of age above 12 years comprising:
a. a fresh weeds composition containing whole weed Amaranthus retroflexus (pigweed), whole weed Taraxacum officinale (dandelion) excluding unwanted parts of the roots, whole weed Urtica dioica (stinging nettles) excluding its nettles, and whole weed Chenopodium album (lamb's quarters) taken in the ratio of 5:4:2:4 respectively provided said fresh weeds composition weigh at least 750 gms; and
b. the cornmeal in the amount of 250 gms.

2. A dietary nutritional formulation to meet the recommended dietary allowance of a malnourished human being comprising:
a. a dried weeds composition containing whole weed Amaranthus retroflexus (pigweed), whole weed Taraxacum officinale (dandelion) excluding unwanted parts of the roots, whole weed Urtica dioica (stinging nettles) excluding its nettles, and whole weed Chenopodium album (lamb's quarters) taken in the ratio of 5:4:2:4 respectively provided said dried weeds composition weigh in the range of 60 to 80 gms; and
b. the cornmeal in the amount of 250 gms.

3. A dietary nutritional formulation to meet the recommended dietary allowance of children suffering from Marasmus or Kwashiorkor comprising:
a. a dried weeds composition containing whole weed Amaranthus retroflexus (pigweed), whole weed Taraxacum officinale (dandelion) excluding unwanted parts of the roots, whole weed Urtica dioica (stinging nettles) excluding its nettles, and whole weed Chenopodium album (lamb's quarters) taken in the ratio of 5:4:2:4 respectively provided said dried weeds composition weigh in the range of 60 to 80 gms; and
b. the cornmeal in the amount of 250 gms.

4. A dietary nutritional formulation to meet the recommended dietary allowance of a healthy human being of age between 1 to 6 years comprising:
a. a dried weeds composition containing whole weed Amaranthus retroflexus (pigweed), whole weed Taraxacum officinale (dandelion) excluding unwanted parts of the roots, whole weed Urtica dioica (stinging nettles) excluding its nettles, and whole weed Chenopodium album (lamb's quarters) taken in the ratio of 5:4:2:4 respectively provided said dried weeds composition weigh in the range of 60 to 80 gms; and
b. the cornmeal in the amount of 250 gms.

5. A dietary nutritional formulation to meet the recommended dietary allowance of a healthy human being of age between 7 to 9 years comprising:
a. a dried weeds composition containing whole weed Amaranthus retroflexus (pigweed), whole weed Taraxacum officinale (dandelion) excluding unwanted parts of the roots, whole weed Urtica dioica (stinging nettles) excluding its nettles, and whole weed Chenopodium album (lamb's quarters) taken in the ratio of 5:4:2:4 respectively provided said dried weeds composition weigh in the range of 140 to 160 gms; and
b. the cornmeal in the amount of 250 gms,

6. A dietary nutritional formulation to meet the recommended dietary allowance of a healthy human being of age above 12 years comprising:
a. a dried weeds composition containing whole weed Amaranthus retroflexus (pigweed), whole weed Taraxacum officinale (dandelion) excluding unwanted parts of the roots, whole weed Urtica dioica (stinging nettles) excluding its nettles, and whole weed Chenopodium album (lamb's quarters) taken in the ratio of 5:4:2:4 respectively provided said dried weeds composition weigh at least 274 gms; and
b. the cornmeal in the amount of 250 gms.

7. A dietary nutritional formulation as claimed in claim 1, wherein the moisture content in dried weeds is not more than 14%.

8. A dietary nutritional formulation as claimed in claim 1, wherein cornmeal is roasted using 15 grams of oil.

9. A dietary nutritional formulation as claimed in claim 8, wherein the oil is coconut oil.

10. A dietary nutritional formulation as claimed in claim 1, wherein the dietary nutritional formulation is further added with food ingredients to enhance taste.

11. A dietary nutritional formulation as claimed in claim 10, wherein the food ingredients are dehydrated fruit selected from apple, banana, grapes, guava, jackfruit and mango.

12. A dietary nutritional formulation as claimed in claim 11, wherein the food ingredients are selected from spices, chilly and salts.

13. A dietary nutritional formulation as claimed in claim 1, wherein the dietary nutritional formulation is further added with water to form a batter for ‘chinas’, ‘dosas’ or ‘pakoras’.
